(19) United States
(12) Patent Application Publication
(10) Pub. No.: US 2017/0284193 A1
(43) Pub. Date: Oct. 5, 2017

(54) Collection And Display Of Acoustic Data For Integrated Quality Control

(71) Applicant: Halliburton Energy Services, Inc, Houston, TX (US)

(72) Inventors: Zhijuan Zhang, Houston, TX (US); Rong Shu, Sugar Land, TX (US); Xiaobin Song, Beijing (CN); Arthur Cheng, Houston, TX (US)

(21) Appl. No.: 15/511,151

(22) PCT Filed: Nov. 11, 2014
(86) PCT No.: PCT/US2014/064994

§ 371 Date: Mar. 14, 2017

(51) Int. Cl. E21B 47/12; G01V 1/50; G01V 1/52

(52) U.S. Cl. CPC E21B 47/124; G01V 1/52; G01V 1/50; G01V 2001/526

(57) ABSTRACT

In some embodiments, a method acquires acoustic data with a receiver. The acoustic data is provided by a down hole tool, comprising the receiver, that can move within a borehole in a geological formation. Quality control workflow charts, representing selected acoustic data related to the down hole tool, the geological formation, and/or the borehole can be displayed, transformation controlled, and analyzed on a monitor. The quality control workflow charts comprise the selected acoustic data and/or transformed versions of signal waveforms of the selected acoustic data.

### BACKGROUND

Understanding the structure and properties of geological formations can reduce the cost of drilling wells for oil and gas exploration. Measurements made in a borehole (i.e., down hole measurements) are typically performed to attain this understanding, to identify the composition, structure, properties, and distribution of material that surrounds the measurement device down hole. To obtain such measurements, logging tools of the acoustic type are often used to provide measurement information that is directly related to geo-mechanical properties.

Traditional acoustic logging tools utilize transmitters to create pressure waves inside the borehole fluid, which in turn create several types of waveguide modes in the borehole. These modes can be processed to determine formation properties, such as compression and shear wave velocity of the formation.

Using acoustic processing software, the acoustic data collected from the acoustic tool operation can be displayed for interpretation and analysis. However, such displays of acoustic data have been limited to receiver balance checks and variable density logs, resulting in a need for a more informative quality control workflow.

### BRIEF DESCRIPTION OF THE DRAWINGS

FIG. 1 is a block diagram showing an embodiment of an integrated quality control system.

FIG. 2 is a plot showing an integrated quality control display for selected data in accordance with the embodiment of FIG. 1.

FIG. 3 is a plurality of plots showing selected dipole acoustic data for quality control in accordance with the embodiment of FIG. 2.

FIG. 4 is a plurality of plots showing selected monopole acoustic data for quality control in accordance with the embodiment of FIG. 2.

FIG. 5 is a diagram showing an embodiment of a wireline system in accordance with various embodiments.

FIG. 6 is a diagram showing an embodiment of a drilling rig system in accordance with various embodiments.

FIG. 7 is a flowchart showing an embodiment of a method for collecting and displaying selected acoustic data for integrated quality control.

### DETAILED DESCRIPTION

To address some of the challenges described above, as well as others, apparatus, systems, and methods for performing data interpretation and quality control of monopole and dipole acoustic data are described. The described embodiments can provide not only traditional operational check functions of a acoustic tool but can perform acoustic processing (e.g., transformation) and selected display of the monopole and dipole acoustic data to provide data quality control that enables interpretation of the selected results.

The monopole/dipole quality control workflows present waveforms received from individual sensors, decomposed waveforms, and dispersion analysis. Based on the quality control workflow, data users can, for example, check model purity for monopole/dipole transducers and strength of signals, implement preliminary anisotropy analysis, investigate borehole condition, and/or validate flexural waves.

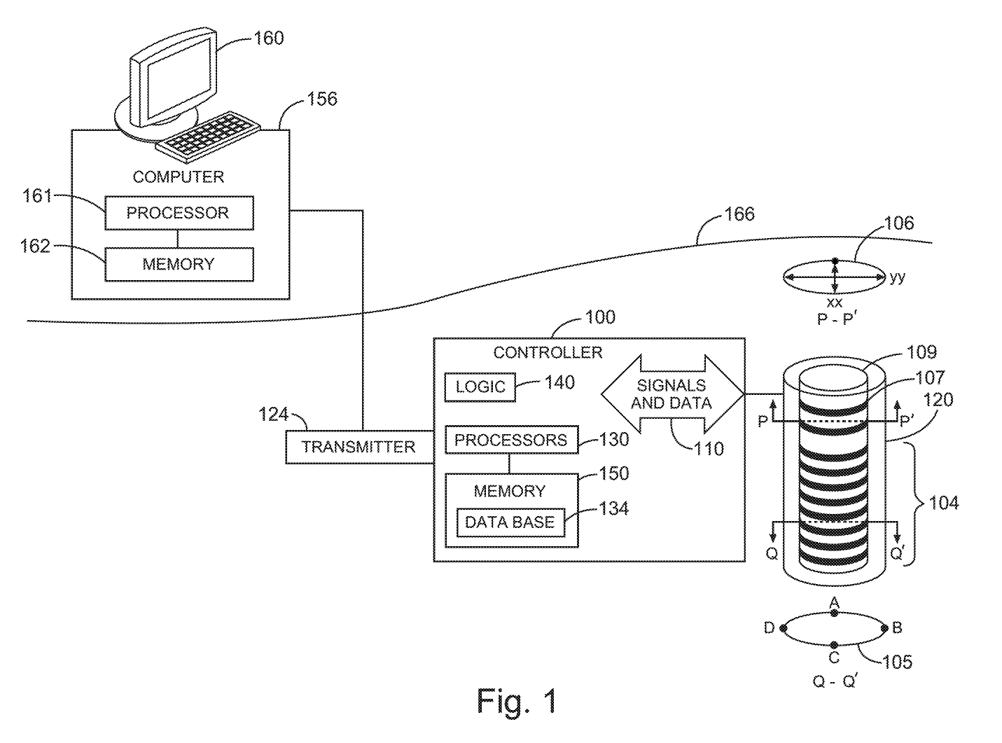

FIG. 1 is a block diagram showing an embodiment of an integrated quality control system in accordance with various embodiments. The system of FIG. 1 is for purposes of illustration only as the acoustic logging tool can have different quantities of transducers/receivers, different tools can be used in the system, and/or the system can incorporate different controllers depending on the type of tool implemented.

The system can include a combination of one or more down hole tools 109, and one or more controllers 100. Either one of the tool 109 and/or the controller 100 can be located inside or outside of a tool body 120 or attached to the outside of the tool body 120.

The tool 109 includes two dipole transducers and one monopole transducer represented as transducer rings 107. As shown in the cross-sectional view 106, two perpendicular transmitters (XX, YY) are placed on two transducer rings 107 separately.

The tool 109 can further comprise an array of receiver rings 104. In the illustrated embodiment, the array of receiver rings 104 comprises eight receiver rings (e.g., channels). As shown in the cross-sectional view 105, each receiver ring 104 comprises four receivers (A, B, C, D) located azimuthally on the tool 109. For the XX transducer, receivers A and C are inline while receivers B and D are cross-line. For the YY transducer, receivers B and D are inline while receivers A and C are cross-line.

The directions of transducer 107 and receiver 104 are used and discussed subsequently with reference to the various display embodiments. The structure of the tool 109 is configured symmetrically to excite dipole modes or monopole modes within a geological formation.

A controller 100 can be coupled to the tool 109 for controlling operation of the tool 109 (e.g., transmission of signals) as well as retrieving data from the tool 109. The data can include acoustic data if the tool includes acoustic transducers 107 and receivers 104, as illustrated.

The controller 100 can comprise a programmable drive and/or sampling control system. The controller can include logic 140 for acquiring acoustic data and/or signals 110 from the tool 109. Memory 150, located inside or outside the tool body 120, can be used to store acquired data, and/or processing results (e.g., perhaps in a database 134). The memory 150 is communicatively coupled to the processor(s) 130. While not shown in FIG. 1, it should be noted that the memory 150 may be located down hole, or above the surface of the geological formations 166.

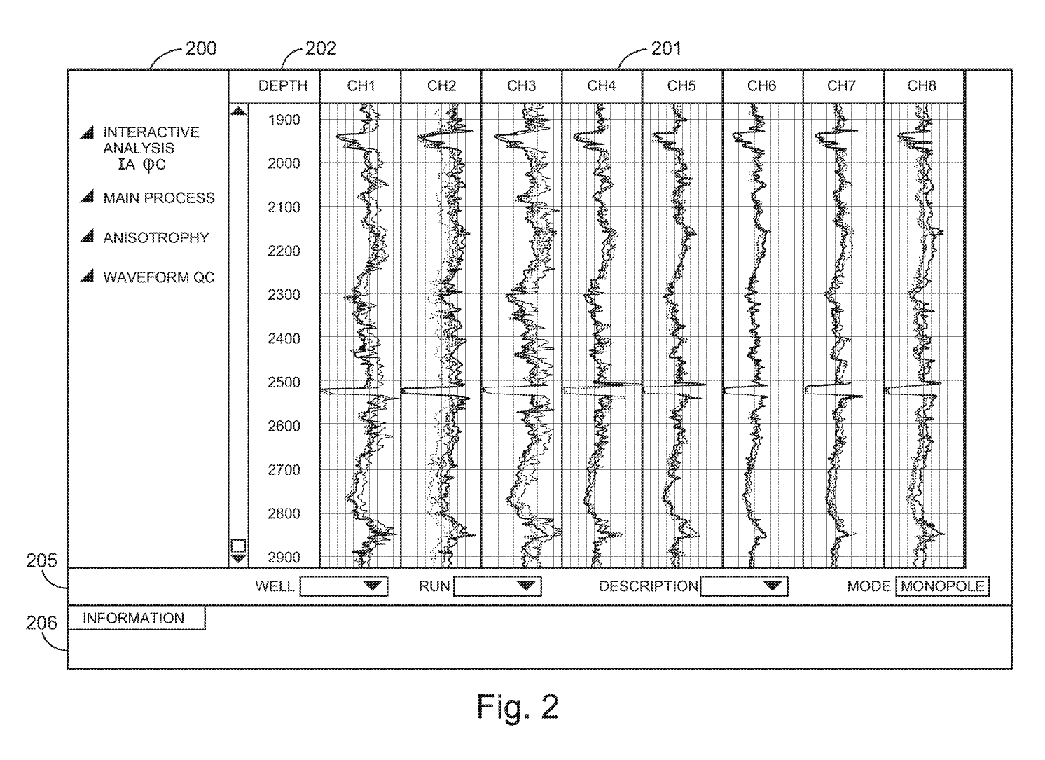

A data transmitter 124 may be used to transmit data and/or signals to the surface 166 for display by the quality control system as illustrated in FIGS. 2-4. Thus, the system may include the data transmitter 124 (e.g., a telemetry transmitter) to transmit the data to a surface data processing computer 156.

The system can further include a computer 156 coupled to and configured to communicate with, control, and/or display data received from the controller 100. The computer 156 can include a processor 161 and memory 162 for controlling the system. A monitor 160 can be coupled to the computer for displaying data that can include acoustic data, transformed (e.g., filtered) acoustic data, dipole acoustic quality control data, and/or monopole acoustic quality control data. The computer 156 can be configured to execute the various methods for collection and display of elected acoustic data for integrated quality control.

FIG. 2 is a plot showing an integrated quality control display for selected data in accordance with the embodiment of FIG. 1. Such a display can be viewed on the monitor 160 of FIG. 1 by petrophysicists or other users of the integrated quality control system of FIG. 1. The display is for purposes of illustration only as other embodiments can display the data in other formats. The format may change based on the number and/or type of transmitter/receiver (e.g., monopole, dipole, multipole).

The display comprises a quality control workflow panel 200 that can include a list of different quality control workflows that can be selected by a user. The workflows can include various filtering or other transformations of the acoustic data received from the tool. The transformed data can then be displayed on the right side 201 of the display and/or on another display using another display format.

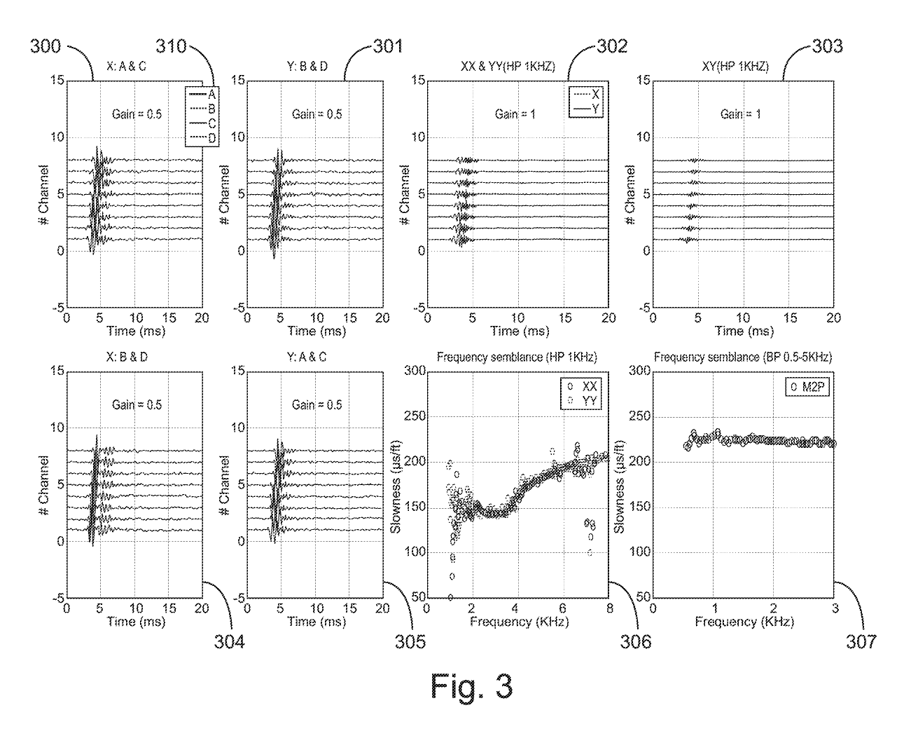

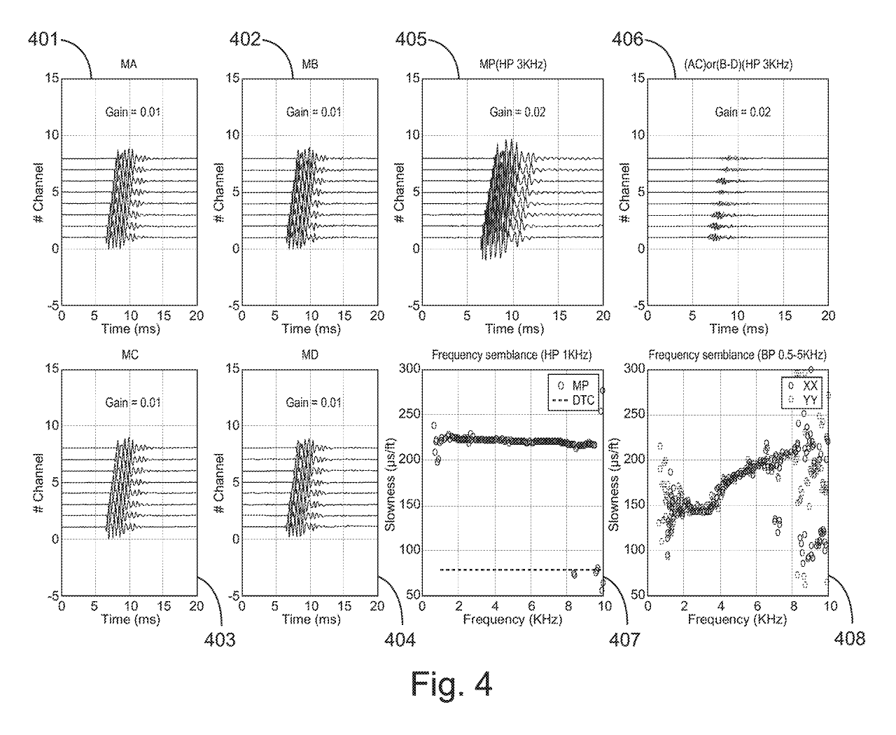

The right side 201 of the display can display the various signal channels for displaying data from the receiver channels of the tool. The illustrated data is the receiver signal quality control for each channel along with a corresponding depth 202 for the displayed signal. The right side 201 of the display can also be used to display the selected transformed acoustic data as selected from the quality control workflow panel 200. Examples of such displays are illustrated in FIGS. 3 and 4 as discussed subsequently.

The display can further include additional fields 205, 206. For example, an information field 206 can include additional information regarding the quality control workflow. A data transformation selection area 205 can include pull-down menus (e.g., selectable filter representations) for selecting additional filters 205 for transforming the displayed data. For example, the data transformation selection area 205 can include pull-down menus for selecting to display received signals from different wells and/or for selecting monopole/dipole mode.

FIG. 3 is a plurality of plots showing selected dipole acoustic data for quality control in accordance with the embodiment of FIG. 2. These quality control workflow charts are generated from data from a dipole mode of a tool having acoustic transducers. Quality control workflow charts 300-305 are plots of received data (e.g., signals) showing the channel number along the y-axis and time in milliseconds (ms) along the x-axis. Workflow charts 306-307 show plots of the received data (e.g., signals) showing frequency in kilohertz (kHz) along the x-axis and the detected slowness in microseconds/foot (μs/ft) along the y-axis.

The left-most charts 300, 304 show the waveforms of signals received by individual receivers (e.g., A, B, C, D) when the X dipole transducer is excited. For acoustic dipole signals, an ideal transducer only transmits pressure along one axial direction. For X dipole, an inline signal refers to when the transducer transmits a signal in the AC direction, a signal would be received in the AC direction. A signal transmitted (or received) in the BD direction (perpendicular to the AC direction) would refer to a cross-line signal.

The next column of upper 301 and lower 305 charts show resulting signals when the Y transducer is excited. The upper chart 301 shows the inline signals with respect to the Y transducer. The lower chart 305 shows corresponding cross-line signals with respect to the Y transducer.

Each of these chart 300, 304 display waveforms having the same gain (e.g., 0.5) and before model decomposition, since monopole components would always be dominant and thus with normally operating transducers and receivers, charts 300, 301, 304 and 305 would display waveforms having comparably equal amplitude. If any of the signals are displayed having a significant larger amplitude than another signal, the transducer might not be operating properly. Inline and cross-line waveforms with respect to the X dipole transducer are plotted separately and can be identified in the plot by the displayed legend 310.

The upper left-most chart 302 shows inline signals with respect to the X transducer after model decomposition. The upper right-most chart 303 shows corresponding cross-line signals with respect to the X transducer after model decomposition. In terms of cross line and inline signals, users can check model purity of the dipole transducers since cross-line signals are driven by the monopole component excited by the dipole transducer in isotropic medium or formation anisotropy.

The upper chart 302shows inline signals with respect to the Y transducer after model decomposition. The upper right-most chart 303 shows corresponding cross-line signals with respect to the Y transducer after model decomposition. In terms of cross line and inline signals, users can check model purity of the dipole transducers since cross-line signals are driven by the monopole component excited by the dipole transducer in isotropic medium or formation anisotropy.

The right-most upper two upper charts 302, 303 of FIG. 3 can be implemented by users to determine signal strength, borehole condition, and/or preliminary anisotropy analysis. These charts 302, 303 present waveforms after model decomposition. For example, in the upper chart 302, the decomposed inline waveforms (XX and YY) are presented. By comparing the inline waveforms between the XX dipole and the YY dipole in this chart 302, the borehole condition (e.g., ellipse of the borehole) can be investigated. If the XX dipole shows a larger difference from the YY dipole, it is possible that the borehole is elliptical.

The right-most upper chart 303 shows decomposed cross-line waveforms for XY and YX signals. The decomposed cross-line signal waveforms can be useful to indicate anisotropy. If the borehole condition is good in terms of the upper chart, 302, strong cross-line signals observed at the particular depth can infer anisotropy.

The right-most lower charts 306 and 307 of FIG. 3 can be implemented by users to show dispersion analysis or filter adjustment. These charts 306, 307 show dispersion signals of decomposed inline signal waveforms XX and YY 303 and decomposed cross-line signal waveforms XY and YX 307.

Chart 306 shows a dispersion signal waveform of a flexural wave. The next chart 307 shows a dispersion signal waveform of a monopole component from a dipole transducer that is dominated by a Stoneley wave. Dispersion waveforms of flexural waves and Stoneley waves can be overlaid in a high frequency range (e.g., kilohertz). The dispersion waveform of the flexural wave chases formation shear slowness near its cut-off frequency. The Stoneley wave is slightly dispersive. By comparing the charts 306, 307, users can check if those dispersion curves follow these simple and well known theoretical principles. Additionally, chart 306 can help users capture a better understanding of cut-off frequency of the formation flexural wave and, therefore, more effectively adjust filter frequency bandwidth.

FIG. 4 is a plurality of plots showing selected monopole acoustic data for quality control in accordance with the embodiment of FIG. 2. These quality control workflow charts are generated from data from a monopole mode of a tool having acoustic transducers. For purposes of illustration, the monopole quality control workflow charts of FIG. 4 realize the same functionalities of the dipole quality control charts of FIG. 3.

Quality control workflow charts 401-404 present waveforms of signals received by individual receivers A, B, C, and D, respectively, when the monopole transducer is excited. In terms of A, B, C, and D, users can investigate monopole waveforms, moreover, the borehole condition by reviewing the quality control workflow charts 401-404. Asymmetric Stoneley wave implies nearby borehole damage. Since these signal waveforms have the same gain (e.g., 0.01), any waveform having an amplitude greater than the other waveforms can indicate a problem with the transducer.

Chart 405 shows a signal waveform for decomposed monopole waveforms. Chart 406 shows a signal waveform representing contamination of a dipole component of the monopole transducer. By comparing charts 405, 406, the model purity of the monopole transducer can be determined. Any weak signals waveforms in chart 406 can illustrate the model purity of the monopole transducer.

Chart 407 shows a dispersion waveform of the decomposed monopole waveforms as shown in chart 403. Chart 408 shows a dispersion curve of a flexural wave (XX and YY) from dipole transducers that are transmitting. By comparing charts 407 and 408, users can determine characteristics of dispersion curves of monopole waveforms in greater detail.

The quality control workflow display and charts illustrated in FIGS. 2-4 enable users to efficiently analyze monopole/dipole acoustic data, quality control the tool performance, and implement data interpretation in one space (e.g., time, depth). The quality control workflows can provide a tool to users (e.g., petrophysicists) to evaluate model purity of monopole/dipole/multipole transducers and, therefore, understand the transducer design further. Additionally, users can compare the XX and YY dipole inline signals to investigate the borehole conditions while cross-line signals are good indicators of anisotropy. Moreover, comparisons on dispersion waveforms between the flexural waves and the Stoneley waves can be used to validate flexural waves and Stoneley waves.

The tool of FIG. 1 can be used in a wireline system as part of a sonde, or in a down hole drilling operation, as part of a drill string. An analysis of the acoustic data can be performed using the quality control workflow displays of FIGS. 2-4, with selected data, in order to effect changes in either operation based on the results of the quality control analysis.

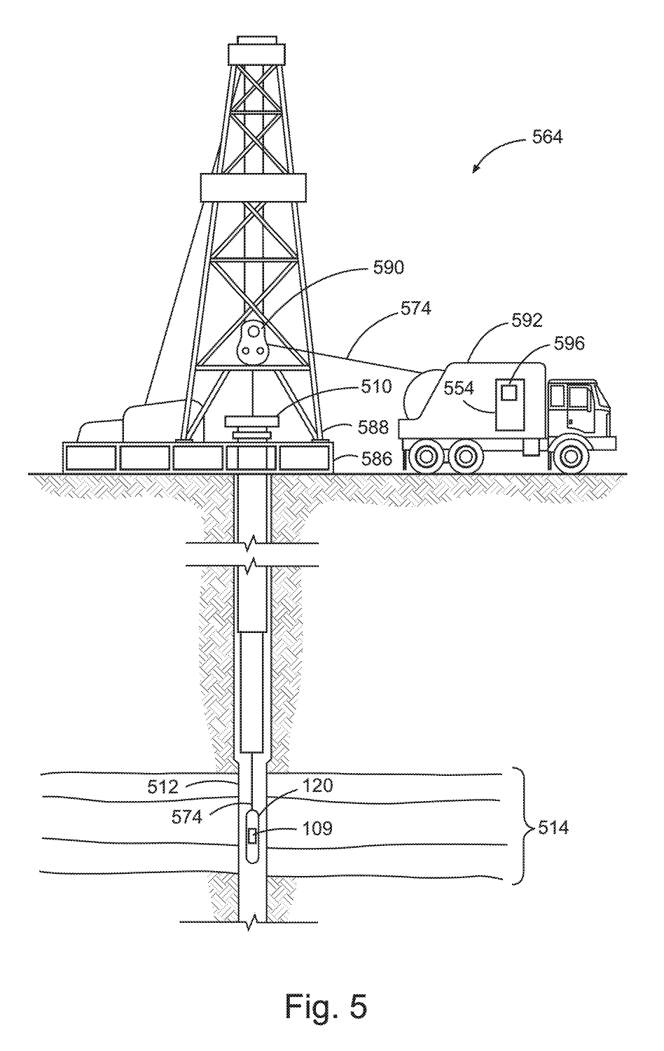

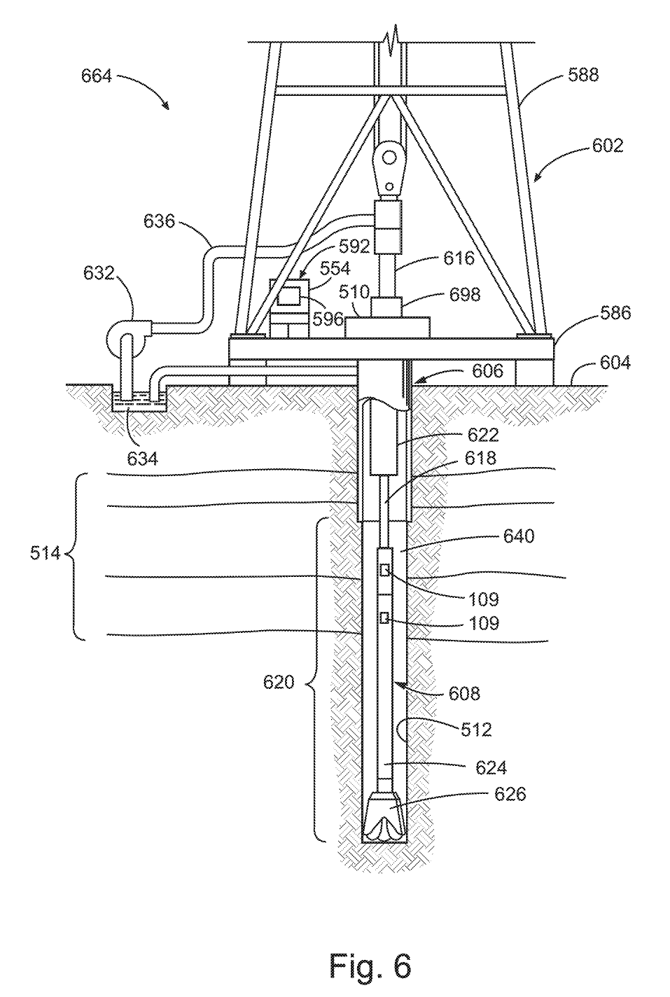

FIG. 5 is a diagram showing an embodiment of a wireline system in accordance with various embodiments and FIG. 6 is a diagram showing an embodiment of a drilling rig system in accordance with various embodiments. Thus, the systems 564, 664 may include portions of a wireline logging tool body 120, as part of a wireline logging operation, or of a down hole tool 624, as part of a down hole drilling operation. The tool of FIG. 1 can be used in either system 564, 664 and the quality control workflow results discussed previously can be used to effect changes in either operation.

FIG. 5 shows a well during wireline logging operations. A drilling platform 586 is equipped with a derrick 588 that supports a hoist 590. Drilling of oil and gas wells is commonly carried out using a string of drill pipes connected together so as to form a drilling string that is lowered through a rotary table 510 into a wellbore or borehole 512. Here it is assumed that the drilling string has been temporarily removed from the borehole 512 to allow a wireline logging tool body 120, such as a probe or sonde, to be lowered by wireline or logging cable 574 into the borehole 512. Typically, the wireline logging tool body 570 is lowered to the bottom of the region of interest and subsequently pulled upward at a substantially constant speed.

During the upward trip, at a series of depths, the instruments (e.g., the transducers 104 and receivers 107 FIG. 1) included in the tool body 120 may be used to perform measurements on the subsurface geological formations 514 adjacent the borehole 512 (and the tool body 120). The received data, that can include acoustic data, can be communicated to a surface logging facility 592 for storage, processing, and/or analysis as described previously. The logging facility 592 may be provided with electronic equipment for various types of signal processing. Similar formation evaluation data may be gathered and analyzed during drilling operations (e.g., during LWD operations, and by extension, sampling while drilling).

In some embodiments, the tool body 120 comprises an acoustic tool for obtaining and analyzing acoustic measurements from a subterranean geological formation through a wellbore. The tool is suspended in the wellbore by a wireline cable 574 that connects the tool to a surface control unit (e.g., comprising a workstation 554). The tool may be deployed in the wellbore on coiled tubing, jointed drill pipe, hard wired drill pipe, or any other suitable deployment technique.

Turning now to FIG. 6, it can be seen how a system 664 may also form a portion of a drilling rig 602 located at the surface 604 of a well 606. The drilling rig 602 may provide support for a drill string 608. The drill string 608 may operate to penetrate a rotary table 510 for drilling a borehole 512 through subsurface formations 514. The drill string 608 may include a Kelly 616, drill pipe 618, and a bottom hole assembly 620, perhaps located at the lower portion of the drill pipe 618.

The bottom hole assembly 620 may include drill collars 622, a down hole tool 109, and a drill bit 626. The drill bit 626 may operate to create a borehole 512 by penetrating the surface 604 and subsurface formations 514. The down hole tool 624 may comprise any of a number of different types of tools including MWD tools, LWD tools, and others.

During drilling operations, the drill string 608 (perhaps including the Kelly 616, the drill pipe 618, and the bottom hole assembly 620) may be rotated by the rotary table 510. In addition to, or alternatively, the bottom hole assembly 620 may also be rotated by a motor (e.g., a mud motor) that is located down hole. The drill collars 622 may be used to add weight to the drill bit 626. The drill collars 622 may also operate to stiffen the bottom hole assembly 620, allowing the bottom hole assembly 620 to transfer the added weight to the drill bit 626, and in turn, to assist the drill bit 626 in penetrating the surface 504 and subsurface formations 514.

During drilling operations, a mud pump 632 may pump drilling fluid (sometimes known by those of ordinary skill in the art as “drilling mud”) from a mud pit 634 through a hose 636 into the drill pipe 618 and down to the drill bit 626. The drilling fluid can flow out from the drill bit 626 and be returned to the surface 604 through an annular area 640 between the drill pipe 618 and the sides of the borehole 512. The drilling fluid may then be returned to the mud pit 634, where such fluid is filtered. In some embodiments, the drilling fluid can be used to cool the drill bit 626, as well as to provide lubrication for the drill bit 626 during drilling operations. Additionally, the drilling fluid may be used to remove subsurface formation 514 cuttings created by operating the drill bit 626.

In some embodiments, a system 564, 664 can include a display 596 to present quality control workflow charts as discussed previously with respect to FIGS. 2-4. The systems 564, 664 can also include computation logic, perhaps as part of a surface logging facility 592, or a computer workstation 554, to receive signals from transducers, receivers, and other instrumentation to determine properties of the formation 514 and to transform acoustic data that has been acquired.

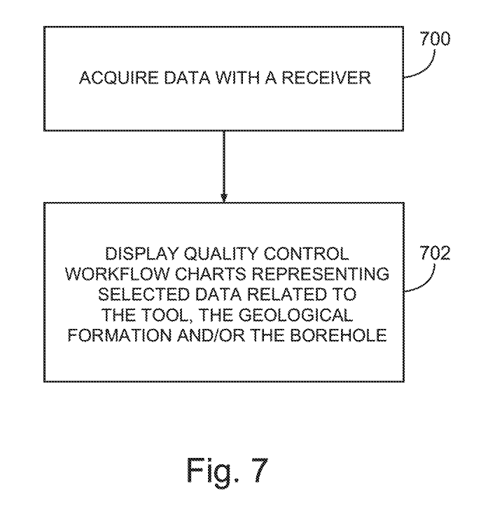

FIG. 7 is a flowchart showing an embodiment of a method for collecting, transforming, and displaying selected acoustic data for integrated quality control. The method acquires the acoustic data with a receiver 700. The acoustic data can be provided by a down hole tool, comprising the receiver, that moves within a borehole in a geological formation.

The quality control workflow charts representing selected acoustic data related to the down hole tool, the geological formation, and/or the borehole are displayed 702. The quality control workflow charts comprise the selected acoustic data and/or transformed versions of signal waveforms of the selected acoustic data.

The processor/controllers/memory discussed herein can be characterized as “modules”. Such modules may include hardware circuitry, and/or a processor and/or memory circuits, software program modules and objects, and/or firmware, and combinations thereof, as appropriate for particular implementations of various embodiments. For example, in some embodiments, such modules may be included in an apparatus and/or system operation for quality control workflow to display integrated quality control charts regarding analysis and/or transformation of downhole data resulting from monopole/dipole/multipole acoustic data.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A processor-implemented method comprising:
acquiring acoustic data with a receiver, the acoustic data provided by a down hole tool, comprising the receiver, moving within a borehole in a geological formation; and
displaying quality control workflow charts representing selected acoustic data related to the down hole tool, the geological formation, and/or the borehole, the quality control workflow charts comprising the selected acoustic data and/or transformed versions of signal waveforms of the selected acoustic data.

2. The method of claim 1, wherein displaying the quality control workflow charts representing the selected acoustic data comprises displaying a plurality of channels of signal waveforms representative, each channel representative of a channel of data received by the receiver.

3. The method of claim 1, wherein displaying the quality control workflow charts representing the selected acoustic data comprises displaying signal waveforms representative of filtered acoustic data.

4. The method of claim 3, further comprising:
displaying a plurality of selectable filter representations; and
displaying signal waveforms representative of filtered acoustic data in response to selection of one of the plurality of selectable filter representations.

5. The method of claim 1, further comprising transmitting an inline signal into the geological formation.

6. The method of claim 5, further comprising displaying a quality control workflow charts representing a cross-line signal with respect to the transmitted inline signal.

7. The method of claim 1, further comprising displaying a plurality of selectable transducer modes.

8. The method of claim 7, wherein the plurality of selectable transducer modes comprise monopole, dipole, and multipole.

9. A method for displaying integrated quality control workflow, the method comprising:
transmitting inline signals from a first transducer and cross-line signals from a second transducer, the first and second transducers coupled to a down hole tool, the inline and cross-line signals transmitted into a geological formation;
acquiring, from the geological formation, inline acoustic data with a first receiver and cross-line acoustic data with a second receiver, the first and second receivers coupled to the down hole tool, wherein the inline and cross-line received acoustic data is acquired while the down hole tool is moving within a borehole in the geological formation; and
displaying quality control workflow charts representing selected acoustic data related to the down hole tool, the geological formation, and/or the borehole, the quality control workflow charts comprising the selected acoustic data and/or transformed versions of signal waveforms of the selected acoustic data.

10. The method of claim 9, wherein displaying comprises displaying quality control workflow charts of representations of both the inline and cross-line acoustic data.

11. The method of claim 9, wherein transmitting comprises the first transducer and the second transducer transmitting signals symmetrically from the down hole tool.

12. The method of claim 9, wherein transmitting comprises the first transducer and the second transducer transmitting signals asymmetrically from the down hole tool.

13. The method of claim 9, wherein displaying comprises displaying a quality control workflow panel and displaying a plurality of channels of signal waveforms that represent the selected acoustic data.

14. The method of claim 9, wherein displaying comprises displaying inline and cross-line representations of received acoustic data resulting from transmitting the inline signal.

15. The method of claim 9, wherein displaying comprises displaying decomposed inline waveforms of the received acoustic data.

16. The method of claim 9, wherein displaying comprises displaying dispersion representations of decomposed inline waveforms and decomposed cross-line waveforms of the received acoustic data.

17. The method of claim 9, wherein displaying comprises displaying dispersion representations of flexural wave representations of the received acoustic data.

18. An apparatus, comprising:
at least one receiver coupled to a tool to acquire acoustic data in a borehole located in a geological formation; and
a processor to process the acoustic data and to display quality control workflow charts representing selected acoustic data related to the down hole tool, the geological formation, and/or the borehole, the quality control workflow charts comprising the selected acoustic data and/or transformed versions of signal waveforms of the selected acoustic data.

19. The apparatus of claim 18, further comprising a plurality of receivers located azimuthally on the tool.

20. The apparatus of claim 18, further comprising a plurality of transducers located azimuthally on the tool, a first transducer configured to transmit an inline signal and a second transducer configured to transmit a cross-line signal with respect to the first transducer.

21. A system, comprising:
a down hole tool body configured to move through a borehole in a geological formation; and
an apparatus attached to the down hole tool body, the apparatus comprising at least one receiver to acquire acoustic data, and a processor to process the acoustic data to display quality control workflow charts representing selected acoustic data related to the apparatus, the geological formation, and/or the borehole, the quality control workflow charts comprising the selected acoustic data and/or transformed versions of signal waveforms of the selected acoustic data.

22. The system of claim 21, wherein the down hole tool body comprises:
one of a wireline tool body, a measurement while drilling tool body, or a logging while drilling tool body.
